(19) United States
(12) Patent Application Publication
(10) Pub. No.: US 2015/0264375 A1
(43) Pub. Date: Sep. 17, 2015

(54) ENCAPSULATION OF VIDEO SCANNING FORMAT INFORMATION FOR MEDIA TRANSPORT AND STORAGE

(71) Applicants: ZTE CORPORATION, Shenzhen, Guangdong (CN); ZTE (USA) INC., Richardson, TX (US); ZTE (UK) LIMITED, Brentford, Middlesex (GB)

(72) Inventors: Ming Li, Nanjing (CN); Gerard Fernando, Mountain View, CA (US); Ping Wu, Eastleigh (GB)

(21) Appl. No.: 14/434,425

(22) PCT Filed: Oct. 9, 2013
(86) PCT No.: PCT/CN2013/084926

§ 371 Date: Apr. 9, 2015

(30) Foreign Application Priority Data
Oct. 10, 2012 (CN) PCTCN2012082721

(51) Int. Cl. H04N 19/46; H04N 19/172

(52) U.S. Cl. CPC H04N 19/46; H04N 19/172

(57) ABSTRACT

A method and apparatus for attaching scanning format information for video data for purposes of media transport or media storage are provided, thus enabling efficient compression, decompression and display of the video data. The information is attached to the media transport or storage format header in the form of a descriptor or as a data structure.

### TECHNICAL FIELD

The present invention relates to video coding, and in particular, relates to encapsulation of video scanning format information for video data for purposes of media transport and storage.

### BACKGROUND ART

Nowadays, video application is developing quickly, and due to a developing tendency of higher definition, higher frame rate and higher compression rate, limitations of the current mainstream video compression standard H.264/MPEG-4 Advanced Video Coding (AVC) become prominent.

In view of such a situation, the ITU-T Video Coding Experts Group (VCEG) and ISO/IEC Moving Picture Experts Group (MPEG) are working together in partnership known as Joint Collaborative Team on Video Coding (JCT-VC) for developing a next generation video compression standard, namely the High Efficiency Video Coding (HEVC) standard.

The design of HEVC incorporates the latest state-of-the-art technologies and algorithmic advances to address the persistent demand for broader usage of video content, video migration to broadband networks, diversification of mobile devices, ever-higher resolutions for cameras and displays, and increasingly high video quality. The major goal of the JCT-VC's project is to achieve the same level of video quality with a substantial savings (e.g. reduction by half) relative to the bit rate required by AVC. Initial measurements of the capability of HEVC, at this stage, indicate that its performance is already meeting or exceeding the targets set by this goal.

So far, the HEVC text specification draft 7 has been issued. But content of the HEVC standard is still being modified and enriched. The first edition of the HEVC standard is expected to be finalized in January 2013, resulting in an aligned text that will be published by both ITU-T and ISO/IEC.

At present, there is a need for a technique by which video data could be more efficiently compressed, decompressed and displayed.

### SUMMARY OF THE INVENTION

The purpose of the present invention is to provide a method, apparatus and system for processing video data, which enables efficient compression, decompression and display of the video data.

To achieve the purpose, the present invention provides a method for processing video data, comprising:

attaching video scanning format information for the video data; and

storing the video data or transporting the video data over a network after the attachment.

Preferably, the method further comprises:

using the attached video scanning format information in one or more of the following operations: video source format indication, video compression, video decompression, and video display.

Preferably, the video scanning format information includes indication of an interlaced or progressive scanning format.

Preferably, the video scanning format information includes indication of whether the video data corresponds to a field or frame scanning format.

Preferably, the video scanning format information includes indication of whether the video data corresponds to a duplicated picture.

Preferably, the video scanning format information is represented by one or more flags.

Preferably, the video scanning format information is physically attached to the video data.

Preferably, the video scanning format information is virtually attached for the video data.

Preferably, the step of attaching video scanning format information for the video data comprises:

including the video scanning format information in a separate file or data structure; and

associating the video scanning format information to the video data.

Preferably, the video scanning format information is associated to the video data by one or more pointers.

Preferably, the step of attaching video scanning format information for the video data comprises:

including the video scanning format information in a data structure if the video data is to be stored; or

including the video scanning format information in a data header or descriptor if the video data is to be transported over a network.

Preferably, the step of attaching video scanning format information for the video data is performed before or after compression of the video data.

To achieve the above purpose, the present invention further provides an apparatus for processing video data, comprising:

an attaching module configured to attach video scanning format information for the video data; and

a storing module configured to store the video data or transport the video data over a network after the attachment.

Preferably, the attaching module is further configured to use one or more flags to represent the video scanning format information.

Preferably, the attaching module is configured to physically attach the video scanning format information to the video data.

Preferably, the attaching module is configured to virtually attach the video scanning format information for the video data.

Preferably, the attaching module is configured to attach the video format information by way of:

including the video scanning format information in a separate file or data structure; and

associating the video scanning format information to the video data.

Preferably, the attaching module is configured to use one or more pointers to associate the video scanning format information to the video data.

Preferably, the attaching module is configured to attach the video format information by way of:

including the video scanning format information in a data structure if the video data is to be stored; or

including the video scanning format information in a data header or descriptor if the video data is to be transported over a network.

To achieve the above purpose, the present invention further provides a system for processing video data, comprising:

an apparatus for generating video data; and

an apparatus for processing the video data as defined above.

The method, apparatus and system for attaching video scanning format information for video data for purposes of media transport or media storage provided in the present invention enables efficient compression, decompression and display of the video data.

### BRIEF DESCRIPTION OF THE DRAWING

FIG. 1 illustrates a flow chart of a method according an embodiment of the present invention.

FIG. 2 illustrates the structure of an apparatus for process video data according another embodiment of the present invention.

FIG. 3 illustrates a system according another embodiment of the present invention.

### PREFERRED EMBODIMENTS OF THE PRESENT INVENTION

Video data is available in either interlaced or progressive scanning format, and knowledge of the format helps to improve the efficiency of the compression system.

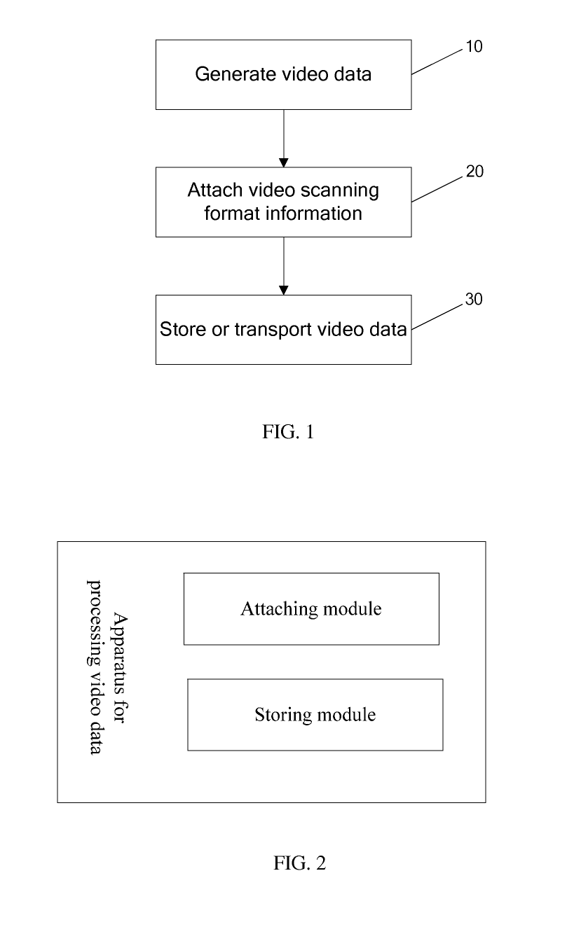

FIG. 1 shows the flow of a method for attaching video scanning format information for video data according to an embodiment of the present invention. The method includes the following steps:

Step 10: video data is generated.

Step 20: video scanning format information is attached for the generated video data. The attachment operation may be performed before or after compression of the video data.

Step 30: the video data is stored or transported over a network.

In the HEVC video compression standard in ISO/MPEG, the scanning information is available. The present invention relates to attaching scanning format information which can then be used at the following four stages in a video compression service:

1. Video source format indication—i.e. whether the video source (i.e. how the video was generated) originated as progressive or interlaced material;

2. Video compression—efficient video compression can be achieved with knowledge about the scanning format of the video data being compressed;

3. Video decompression—if the knowledge of the scanning format were used for efficient video compression then the inverse process (i.e. decompression) must also have the knowledge of the scanning process;

4. Video presentation or display—knowledge of the type of video format helps to determine the best method of video presentation. This includes knowledge of any duplication of video pictures or repetitive pictures.

The information would include (but not limited to) indication of:

(a) whether video data corresponds to a field or frame scanning format;

(b) whether the video data corresponds to a duplicated picture, i.e. a picture that is repeated.

The video scanning format information may be represented by one or more flags. Compressed video data is commonly transported over a network or it is stored. For both cases knowledge of the scanning format enables efficient processing at the decompression and display stages. This information may be physically attached to the compressed video data. Alternatively, such information may be virtually attached. In the context of media transport and storage, one example of virtual attachment is where the scanning information is available in a separate file or data structure, and where there are pointers or similar mechanisms to associate the scanning information to the compressed video data.

Attachment of scanning format information with the compressed video data into the media transport or media storage format is referred to as encapsulation. According to an embodiment of the present invention, attachment of scanning information may be in the form of data headers or descriptors for media transport purposed, and data structures for media storage purposes.

The present invention further provides an apparatus for performing the afore-mentioned video scanning format information attachment operation. According to an embodiment as illustrated in FIG. 2, the apparatus for attaching video scanning format information for video data comprises: an attaching module configured to attach video scanning format information for the generated video data, and a storing module configured to store the video data or transport the video data over a network. The attachment operation may be performed before or after compression of the video data. After the attachment of the video scanning format information, the video data is stored or transported over a network.

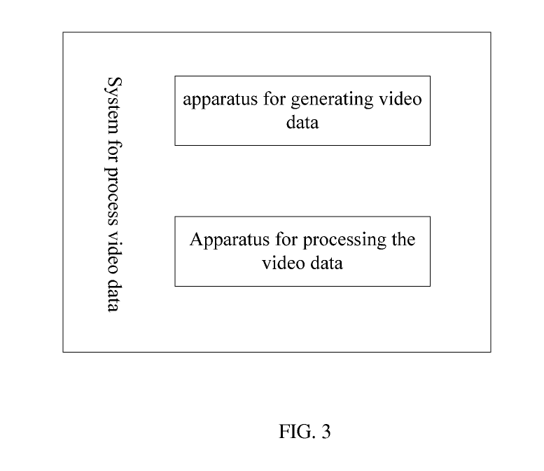

Further, the attaching module may be configured to use one or more flags to represent the video scanning format information. The attaching module may be configured to physically attach the video scanning format information to the generated video data, or to virtually attach the information. In the context of media transport and storage, one example of virtual attachment is to include the video scanning format information in a separate file or data structure, and to use pointers or similar mechanisms to associate the video scanning format information to the video data. The attaching module may be configured to attach the video scanning format information in the form of data headers or descriptors for media transport purpose, and data structures for media storage purpose. The present invention further provides a system for processing video data, according to an embodiment as illustrated in FIG. 3, the system comprising: an apparatus for generating video data; and an apparatus for processing the video data as defined above.

A person skilled in the art should understand that the method and apparatus in the present invention may be realized by hardware, software or firmware. For example, they may be realized by a general computing device(s), or computing device executable programs and thereby can be stored in storage media, or integrated circuits.

What is described in the above are just preferred embodiments of the present invention, and is not intended to limit the present invention. To a person skilled in the art, the present invention may have various modifications and variations. Without departing from the essence and principle of the present invention, all the modifications, equivalent substitutions, improvements, etc., shall all fall within the protection scope of the present invention.

### INDUSTRIAL APPLICABILITY

The method and apparatus for attaching video scanning format information for video data for purposes of media transport or media storage provided in the present invention enables efficient compression, decompression and display of the video data. The present invention is applicable to the video coding field.

1. A method for processing video data, comprising:
attaching video scanning format information for the video data; and
storing the video data or transporting the video data over a network after the attachment.

2. The method as claimed in claim 1, further comprising:
using the attached video scanning format information in one or more of the following operations: video source format indication, video compression, video decompression, and video display.

3. The method as claimed in claim 1, wherein the video scanning format information includes indication of an interlaced or progressive scanning format.

4. The method as claimed in claim 1, wherein the video scanning format information includes indication of whether the video data corresponds to a field or frame scanning format.

5. The method as claimed in claim 1, wherein the video scanning format information includes indication of whether the video data corresponds to a duplicated picture.

6. The method as claimed in claim 1, wherein the video scanning format information is represented by one or more flags.

7. The method as claimed in claim 1, wherein the video scanning format information is physically attached to the video data.

8. The method as claimed in claim 1, wherein the video scanning format information is virtually attached for the video data.

9. The method as claimed in claim 8, wherein the step of attaching video scanning format information for the video data comprises:
including the video scanning format information in a separate file or data structure; and
associating the video scanning format information to the video data.

10. The method as claimed in claim 9, wherein the video scanning format information is associated to the video data by one or more pointers.

11. The method as claimed in claim 1, wherein the step of attaching video scanning format information for the video data comprises:
including the video scanning format information in a data structure if the video data is to be stored; or
including the video scanning format information in a data header or descriptor if the video data is to be transported over a network.

12. The method as claimed in claim 1, wherein the step of attaching video scanning format information for the video data is performed before or after compression of the video data.

13. An apparatus for processing video data, comprising:
an attaching module configured to attach video scanning format information for video data; and
a storing module configured to store the video data or transport the video data over a network after the attachment.

14. The apparatus as claimed in claim 13, wherein the attaching module is further configured to use one or more flags to represent the video scanning format information.

15. The apparatus as claimed in claim 13, wherein the attaching module is configured to physically attach the video scanning format information to the video data.

16. The apparatus as claimed in claim 13, wherein the attaching module is configured to virtually attach the video scanning format information for the video data.

17. The apparatus as claimed in claim 16, wherein the attaching module is configured to attach the video format information by way of:
including the video scanning format information in a separate file or data structure; and
associating the video scanning format information to the video data.

18. The apparatus as claimed in claim 17, wherein the attaching module is configured to use one or more pointers to associate the video scanning format information to the video data.

19. The apparatus as claimed in claim 13, wherein the attaching module is configured to attach the video format information by way of:
including the video scanning format information in a data structure if the video data is to be stored; or
including the video scanning format information in a data header or descriptor if the video data is to be transported over a network.

20. A system for processing video data, comprising:
an apparatus for generating video data; and
an apparatus as claimed in claim 13.
